(19) United States
(12) Patent Application Publication
(10) Pub. No.: US 2014/0238392 A1
(43) Pub. Date: Aug. 28, 2014

(54) ESCAPE HOOD

(71) Applicants: Matthew L. Johnston, Toms River, NJ (US); Jack Hayford, III, Brick, NJ (US)

(72) Inventors: Matthew L. Johnston, Toms River, NJ (US); Jack Hayford, III, Brick, NJ (US)

(73) Assignee: Milspray LLC, Lake Wood, NJ (US)

(21) Appl. No.: 13/781,668

(22) Filed: Feb. 28, 2013

(51) Int. Cl. A62B 17/04; A62B 23/02; A62B 19/00

(52) U.S. Cl. CPC A62B 17/04; A62B 19/00; A62B 23/02
USPC 128/201.25

(57) ABSTRACT

A protective hood with air-purifying filter cartridge for safe escape from a hazardous atmosphere has a system for quickly donning the hood. A fabric strap attached to the rear of the hood has the strap lengths extending forward through circular rings near the chin. Optional enlarged ends prevent the strap from pulling rearward from the rings. Hook-and-loop fasteners are on the hood shell and the strap lengths. To deploy, the user simultaneously tugs on both strap ends to tighten the hood on the head then contacts the mating fastener parts to maintain strap tension. The hood is adjusted to optimum position on the head with a single motion. The hood is light weight and the shell is collapsible permitting the hood to fold on itself to extremely small volume for storage in an emergency kit or small personal luggage.

### FIELD OF THE INVENTION

This invention relates to a light weight, head-covering hood with quick deployment and securement features advantageous for use in rapid escape from environmental hazards. More specifically, the invention relates to a collapsible hood, with face shield, air-filtering cartridge, and a unique closure mechanism that is easy to use in an emergency situation and that attaches the hood securely in place.

### BACKGROUND OF THE INVENTION

Protective hoods and hoods have been used by the military and by various industries to protect against a variety of airborne health hazard agents, such as breathing, skin, eye and other toxins and irritants. A very important utility for protective breathing apparatus is an escape situation calling for an individual to suddenly, unexpectedly, and rapidly depart from a hazardous environment. Many solutions existing in the art are quite effective with respect to their ability to shield the head and provide clean or filtered breathing air when properly deployed. However, traditional escape hoods suffer from a number of serious practical shortcomings.

To be of practical use, an escape hood should be readily available at all times. Moreover, it should be light weight and compact while stored, and quickly deployable. Many conventional escape hoods are not light weight and/or are bulky. It is unlikely for these hoods to be at hand at the instant of an emergency because of the inconvenience of constantly having them near the user. Other protectively effective conventional hoods are complicated to operate and difficult to don. The user will lose time escaping from the hazard while putting on and adjusting the fit of these hoods. It is desirable to have an escape hood that is compact and light in storage condition and thus easy for the user to carry in readiness for use. It is also desired to have an escape hood that is easy to deploy.

Another drawback of conventional escape hoods relates to the effectiveness of breathing protection. The ideal breathing protection is provided by self-contained breathing apparatus that include containers of compressed oxygen. These are large, bulky and heavy. They are useful primarily in industrial hazard areas but are not practical for every day use against home, travel, criminal or terrorist threats. Other conventional escape hoods are smaller, lighter, and more portable because they utilize filtered ambient air for the user to breathe.

Typically, filtered-air hoods include a filter cartridge containing media that screens out solid airborne contamination such as dust from debris. Traditional cartridges also can contain beds of absorbent media, such as activated carbon. Air from outside the hood contaminated with vaporous chemical agents, such as volatile organic compound, is drawn through the filter where the harmful chemical vapors are absorbed into the absorbent, allowing the user to breathe cleaned air. The filter media packed in conventional escape hood cartridges is such that there is excessive resistance to breathing. A user attempting to escape from a dangerous hazard such as a conflagration will likely run. Coupled with the effect of excitement, the user will consume a surge of energy leaving the body relatively weak and breathing hard, if not gasping, for air. This is especially so for many ordinary, non-athletic people carrying out modern sedentary lifestyles. Also, the absorbent media can be consumed too quickly to give the user time to escape from a contaminated area. There is a need to improve the filter cartridges such that escape hoods can have longer durations of effective use and provide low resistance to breathing intake air. The present invention provides a lighter hood that folds conveniently for easy storage.

It is extremely urgent in a sudden, unexpected hazard situation that the escaping individual be able to don, adjust and secure an escape hood as quickly as possible. A very commonly used conventional escape hood that exemplifies the problems associated with rapidly deploying an escape hood is Hood XHZLC60 sold by ZHEJIANG JIANGSHAN ZHEAN FIRE-FIGHTING EQUIPMENT CO. LTD., (No. 56, FIRE FIGHTING INDUSTRIAL PARK, Jingahn, Zhejiang, China). It is has beneficial features such as having a collapsible, aluminized fabric shell for protection from heat and fire, a large transparent sight shield for good viewing by the wearer, and a combination particulate and vapor contaminant filter cartridge. However, it is difficult and awkward to properly adjust the hood once placed over the head. This hood is fixed in position by a strap that must be secured to a jam cleat fastener located near the lower jaw on each side of the head. Because of the jam cleat function, two hands are required for each side. Because both sides need adjustment independently, the sides must be adjusted one-at-a-time. Several iterations of opposite side adjustments may be needed until the hood is properly positioned so that the sight shield and cartridge are located centrally in front of the user's face. These adjustments take valuable time away from escaping from the hazard. The strap is a separate part from the shell of the hood. In the rush to don the hood, the user can easily yank the strap completely away from the shell. Re-stringing the strap through the jam cleat fasteners could take even more time to accomplish. There is a need for improvements to the XHZLC60 escape hood such that adjustments can be made very quickly and reliably.

Some other references that disclose escape hood devices include U.S. Pat. No. 6,609,516, disclosing a smoke escape hood having a breathing filter sized to cover the nose and mouth of a user, U.S. Pat. No. 6,019,468, disclosing a protective hood having attached a spectacle means that can be snapped onto an insert clip on the front piece of a hood, and US Statutory Registration No. H1360 disclosing a lightweight protective gas hood with breathing filter means.

The present invention avoids some problems evident in the above cited references by use of a novel strapping apparatus for securely attaching the hood to a user and saves time for use under emergency conditions.

### SUMMARY OF THE INVENTION

The present invention provides a novel protective hood having an easy to use strapping system for fitting and attaching the hood securely to a user. The hood uses a strap attached at its middle to the rear of the hood with the strap lengths extending alongside the hood to the front and through circular rings in the chin region of the hood. An enlargement at each end of the strap prevents the strap from pulling rearward out of the rings. A hook and loop fastener system with one part on the shell of the hood near each of the user's ears and a mating second part on two sections of the strap allows the user to simultaneously tug outwardly on both strap ends to pull the back of the hood towards the rings and then contact the mating parts of the fasteners in a single motion to maintain strap tension. The taught strap around the back of the hood keeps the hood in optimum position. The invention further uses an improved breathing canister system. The hood is light weight and is easy to store in a back pack or purse.

The invention thus provides a protective hood for a user to wear in emergency escape from a life-threatening hazard comprising, (a) a collapsible shell of vapor barrier material defining a front side and a back side, (b) integrated into the front side, a broad, transparent sight shield, (c) a cartridge adapter for a breathing air filter cartridge disposed on the shell forward and below the sight shield, (d) a combination particulate filter and chemical vapor absorbing breathing air cartridge attached to the cartridge adapter, (e) a left side ring pivotally affixed forward on the shell proximate the chin of the user, (f) a right side ring pivotally affixed forward on the shell proximate the chin of the user, and (g) a single elongated strap, in which the strap extends from a left end disposed forward of the hood (i) rearward through the left ring, (ii) rearward along the left side of the hood to the back of the hood, (iii) forward along the right side of the hood, (iv) forward through the right ring to a right end, and in which the right end and left end each comprises handle means for manually grasping the respective end.

There is also provided method of donning a protective hood by a user in emergency escape from a life-threatening hazard comprising the steps of (A) providing a protective hood comprising (1) a collapsible shell of vapor barrier material defining a front side and a back side, (2) integrated into the front side, a broad, transparent sight shield, (3) a cartridge adapter for a breathing air filter cartridge disposed on the shell forward and below the sight shield, (4) a combination particulate filter and chemical vapor absorbing breathing air cartridge attached to the cartridge adapter, (5) a left side ring pivotally affixed forward on the shell proximate the chin of the user, (6) a right side ring pivotally affixed forward on the shell proximate the chin of the user, (7) a single elongated strap, (8) a first part of a hook-and-loop style fastener outside the shell in an area proximate to the left ear of the user, (9) another first hook-and-loop style fastener part outside the shell in an area proximate to the right ear of the user, in which the strap extends from a left end disposed forward of the hood (i) rearward through the left ring, (ii) rearward along the left side of the hood to the back of the hood, (iii) forward along the right side of the hood, (iv) forward through the right ring to a right end, and in which the right end and left end each comprises handle means for manually grasping the respective end, and in which an outwardly facing side of the strap further comprises a section of a second hook-and-loop style fastener part intermediate the left ring and the left end and a section of a second hook-and-loop style fastener part intermediate the right ring and the right end, (B) placing the protective hood over the head of the user such that the sight shield, cartridge adapter and cartridge are covering the face of the user, (C) simultaneously grasping the handle means of the left end by the user's left hand, and grasping the handle means of the right end by the user's right, (D) simultaneously drawing the right end and left end rearwardly along respective sides of the hood with tension effective to bias the strap extending between the left ring and the right against the back of the head of the user, and (E) contacting the first hook-and-loop style fastener part on the shell with the corresponding second hook-and-loop style fastener part of the strap on each side of the hood, thereby attaching the strap to the hood such that the hood is properly secured in place on the user's head.

### BRIEF DESCRIPTION OF THE DRAWINGS

FIG. 1 is a front elevation view of the hood according to this invention prior to tightening the strap. A user's body is shown in phantom lines for clarification.

FIG. 2 is an elevation view of the left side of the hood in condition as in FIG. 1.

FIG. 3 is an elevation view of the right side of the hood of FIG. 1 shown with the strap pulled back and secured under tension by a hook-and-loop style fastener.

FIG. 4 is a rear elevation view of the hood of FIG. 1.

FIG. 5 is a cross section view illustrating preferred features of a preferred breathing air filter cartridge according to this invention.

### DETAILED DESCRIPTION OF THE INVENTION

Recognizing that the novel escape hood is contemplated for use by wearing on a person's head, this disclosure adopts the convention that locations such as “left”, “right”, “front”, “back”, “forward, “rear” and the like, refer to corresponding positions of the user's head.

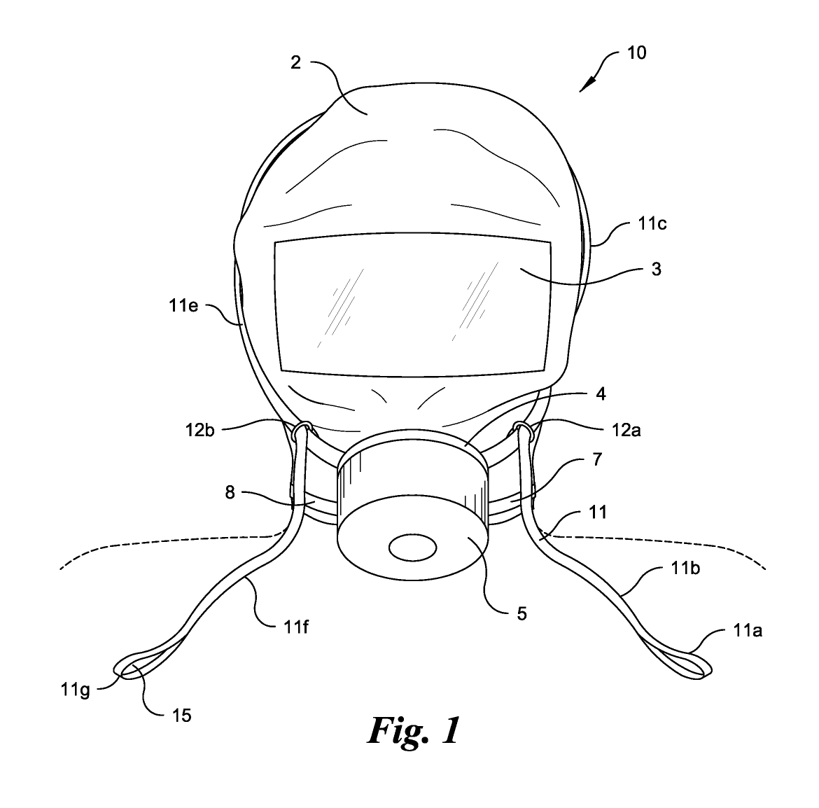

Although the novel features that are the subject of this invention can be applied to different styles of escape hood, they apply most directly and very effectively to the model XHZLC60 escape hood sold by ZHEJIANG JIANGSHAN ZHEAN FIRE-FIGHTING EQUIPMENT CO. LTD., (No. 56, FIRE FIGHTING INDUSTRIAL PARK, Jingahn, Zhejiang, China). The present invention can be better understood with reference to FIGS. 1-4. In the drawings, like parts have the same reference numbers. It provides a protective hood 10 having a head sized shell 2 including a sight shield 3 and an adapter 4 for a filter cartridge 5 on the front. The shell is a material having vapor and liquid barrier properties. This provides protection for the user from penetration by external gas or liquid agents adverse to health. Preferably the shell is a flexible fabric. A foil, polymeric film or metalized fibrous fabric are representative types of material that are preferred for the shell material. A metalized fibrous fabric will help reflect heat away from the user. Although not designed to protect against assault by solid objects, the pliant nature of the shell permits it to be collapsed to a compact size for inconspicuous storage so that the hood can be readily available to deploy on short notice. Optionally, the shell can include a lining of thermally insulating material. Preferably, the wall thickness of the shell will be kept as thin as possible, thereby allowing the hood to be collapsed to light weight and to as small a size as possible for optimum storage purposes.

The sight shield 3 is a transparent optical element to provide for good visibility for the user. It can be a soft pliant film, such as clear polyvinyl chloride. Optionally it can be a semi-rigid material that would also provide some facial protection from flying solid debris. This escape hood, other than the cartridge and a few rigid parts, advantageously is composed largely of pliant materials such that the hood can be collapsed to a very small volume thereby allowing hood to fit in a minimal size package for optimum storage efficiency, convenience and portability.

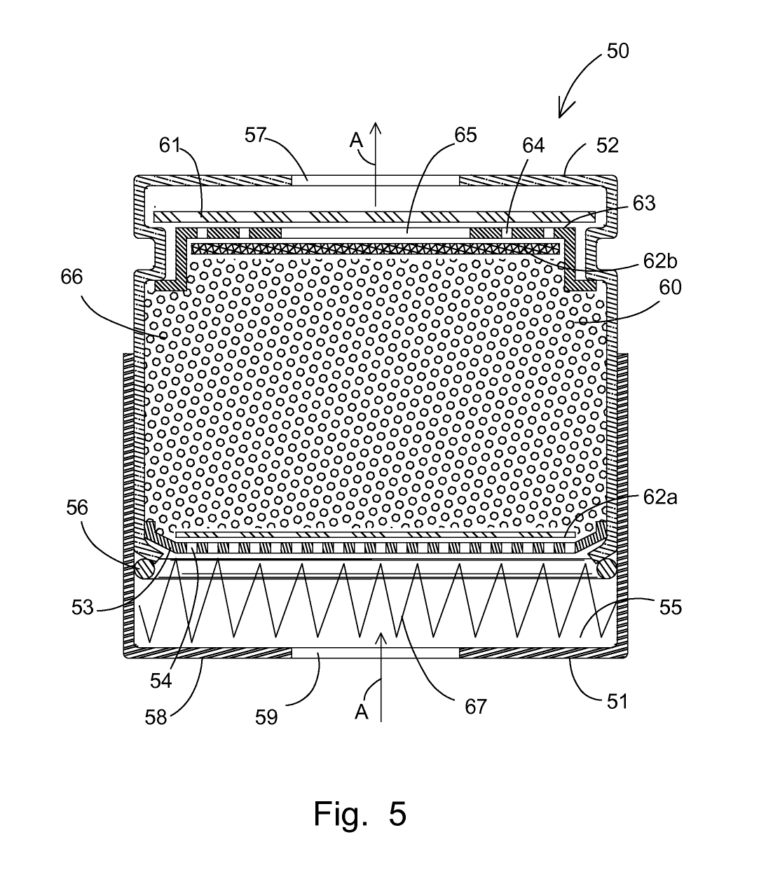

The adapter 4 is typically a cylindrical flange extending forward on the escape hood and suitable for mounting an air-filtering breathing cartridge 5 in the area of the user's nose and mouth. The inner diameter of the cylindrical flange is selected to mate with the outside diameter of a cylindrical cartridge outer wall 55 (FIG. 5). A ring clamp around the flange securely affixes the cylinder to the adapter. The novel escape hood is mainly intended to be used for one time only and to be discarded thereafter. Eventually the particulate and chemical air-purifying ability of a cartridge will be exhausted after a period of use that depends on the quality of the ambient air being purified. Optionally, replacement cartridges can be used to substitute for spent cartridges. A removable ring clamp, such as a screw-tightening clamp, can be used to allow spent cartridges to be replaced.

The escape hood further includes a preferably elastic neck strap 7 that encircles and clamps the collar 8 of the hood to the user's neck. The neck strap produces a seal of the collar against the neck thereby preventing hazardous environmental air from migrating upward inside the hood through the gap between neck and collar.

The novel escape hood is primarily intended for emergency escape situations. Although many conventional emergency escape hoods are designed only to protect against brief exposure to hazardous environmental conditions and one-time-only use, it is contemplated that longer duration exposure might occur. The exposure might be so long as to exhaust the capacity of a single filter cartridge. Consequently, the novel hood has ability to replace a spent cartridge with a fresh one. Various methods can be used to attach the cartridge to the adapter, such as screw fitting, pressure fitting and hose clamp, to identify a few for example.

The preferred filter cartridge of the novel hood is a multi-function element. It includes particulate filter elements such as filter paper to prevent entry inside the hood of particles that present a breathing hazard. These can be dust or debris particles that may be toxic or non-toxic but irritating to breathe. The cartridge also includes a chemical absorbent material, such as activated carbon. The absorbent is in a granular form. Ambient air breathed in through the cartridge first passes through the absorbent material that sorbs selected chemical compounds onto the granules allowing the remaining air taken in to be breathed by the user.

The original equipment manufacturer (“OEM”) cartridge supplied by Zhejiang Jiangshan Zhean with the XHZLC60 escape hood has been found to be somewhat deficient, particularly in volume of air flow and carbon monoxide filtering characteristics for a higher quality escape hood desired in the present end use application. The OEM cartridge has too great a pressure drop (i.e., resistance) to breathing air flow under emergency conditions. It is expected that an individual moving rapidly to effect an escape in a likely state of anxiety will breathe heavily and demand a high volume of air. Also, the OEM XHZLC60 escape hood cartridge is able to filter particulates and absorb some volatile organic chemical (“VOC”) components but it cannot protect against carbon monoxide in breathing air. Carbon monoxide is a toxic, odor-free gaseous byproduct of combustion. It is contemplated that burning materials in a disaster situation will generate dangerous amounts of carbon monoxide. Furthermore, portable electric generators and other small internal combustion engine-driven apparatus will likely be in prevalent use shortly after a casualty to public utilities. These apparatus produce exhaust containing carbon monoxide. It is desired to have a breathing air cartridge for use with the escape hood that has low breathing resistance (i.e., is easy to breath through) and has protection for carbon monoxide as well as for particulates and VOC materials.

The OEM cartridge for the XHZLC60 escape hood has two stacked sections arranged a cylindrical body. The first section in use is farther from the face and holds filter paper folded in an accordion style. The second section in use is closer to the face. This section contains a bed of activated carbon granules adapted to absorb VOC components in the air breathed in during use.

Improvements to the OEM cartridge developed for this invention can be understood with reference to FIG. 5. This drawing shows a modified breathing air cartridge 50 with first section of the case 51 fitting as a sleeve over the second section 52 of the case. An O-ring seal 56 is provided to prevent flow to or from ambient air between the case sections. Walls of case sections 51 and 52 are thin and composed of sheet metal. Outside air is taken in through a large opening 59 in case section 51 at the far end 58 of the cartridge. Air flow direction is shown by arrows A. Incoming air first travels through a pleated sheet of filter paper 67 intended to remove particulate contamination in the ambient air, such as dust, dirt, ash and the like. A first separator 53 of a sheet of preferably polymeric composition divides the interior of the cartridge between first chamber 55 and second chamber 66. Air cleaned of incoming particulate matter by the pleated filter passes through the first separator via perforations 54 and flows into second chamber 66. This chamber is filled with a bed of finely divided granules 60 the purpose of which is to remove chemical contaminants of the incoming air by selectively absorbing these contaminants onto the granules and/or reacting the contaminants with the compositions of the granules. A flat sheet of filter paper 62a lines the surface of first separator 53 inside second chamber 66 to prevent the granules from passing into first chamber 55 and interfere with the pleated filter paper 67. A second separator 63 of preferably polymeric composition covers the bed of granules and includes perforations 64 for cleaned air to pass. There is an additional, substantially flat, porous medium filter element 62b within second chamber 66 and lying adjacent to second separator 63. This filter element prevents whole or abraded pieces of granules from flowing through perforations 64, thereby stopping granular particles from traveling into the air breathed by the cartridge user. Chemically cleaned and particulate-free air discharges from the cartridge through a large opening 57 in case section 52 and then enters the hood to be breathed by the user.

One preferred modification to the OEM XHZLC60 escape hood cartridge removes a circular, 2¼ inch (5.7 cm) diameter section 65 from the center of second separator 63. Originally supplied by the manufacturer, this separator was a sheet with circular perforations of approximately 1/8 inch (3.2 mm) diameter over the whole area of the sheet. Providing a large central opening exposes much more of the flat sheet of filter medium 62b and reduces air flow resistance to make breathing considerably easier. Additionally, filter medium 62b is changed. The original manufacturer supplied filter paper. This paper has been replaced by an approximately 3 inch (7.6 cm) diameter layer of more porous fabric material. Representative examples of suitable fabric material include style no. 07544059 polyester chiffon white fabric, style no. 00401703 nylon white matte tulle fabric and Pellon® Tru Grid™ white No. 810 polyester fabric. These fabrics are available from JoAnn Fabrics & Crafts® retail stores. Still another modification to improve cartridge performance has been to insert between second separator 63 and the breathing air discharge end of second case section 52 an approximately 3.25 inch (8.3 cm) diameter circular multilayer filter 61. This filter meets the National Institute of Occupational Safety and Health (“NIOSH”) P100 filtration rating. NIOSH P100 rated filter medium is approved for air-purifying breathing apparatus and rejects 99.97% of airborne particles while being strongly resistant to oil. P100 filter medium is available from various suppliers such as North by Honeywell (Honeywell Safety Products, Smithfield, R.I.). The extra P100 filter provides additional particle removal from air being breathed by the user of the escape hood.

Another modification from the originally supplied cartridge concerns the chemical neutralizing granules 60. The original manufacturer supplied granules advertised as being capable of absorbing organic contaminants in the air and removing carbon monoxide were replaced with an improved granule mixture. This mixture included activated carbon to absorb organic contaminants in the air and carbon monoxide-reactive granules in chamber 66. A preferred carbon monoxide-reactive granule is a hopcalite type catalyst known as Carulite®-300 from Carus Corporation, Peru, Ill., or Monoxycon™ from Lawrence Factor, Incorporated, Miami Lakes, Fla. This material oxidizes carbon monoxide to carbon dioxide. Preferably the mixture of activated carbon and carbon monoxide-reactive granules is free of dust and fine particles that can occlude the particulate filter media of the cartridge. This can be accomplished by filtering the granules through a sieve prior to inserting them in the cartridge.

Filtration sieve sizes of at most 12-20 mesh by ASTM-E-11, ANSI, AASHTO-M92 and ISO standards is recommended for this purpose. Optionally, an enlarge cartridge with a bigger volume for chamber 66 can be used to accommodate greater quantities of granules than originally supplied in the XHZLC60 escape hood. Providing more chemical neutralizing granules increases duration of effectiveness of the cartridge for chemical removal.

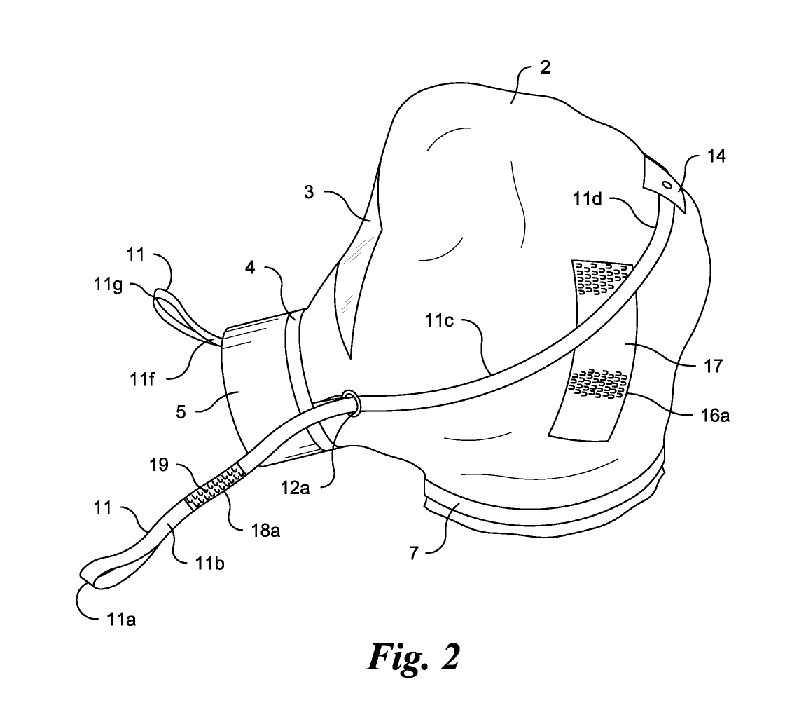

Strap 11 and related parts of the hood are very important features. The main strap function is to secure the hood firmly in place on the user's head with the sight shield and cartridge properly adjusted for central facial position. FIGS. 1 and 2 illustrate the strap with the hood in condition prior to securing the hood in position. Strap 11 is seen to be a single piece structure of a narrow strip of fabric. It extends from a left end 11a in a free-hanging segment 11b forward of the user on the left side, continuing with a segment 11c close to the left side of the hood through a segment across the rear of the hood 11d with a segment close to the right side of the hood 11e, continuing with a free-hanging segment on the right side 11f and terminating at a right end 11g. Along this path, the strap 11 passes through a left ring 12a and a right ring 12b. Preferably, the strap also passes through a belt loop 14 affixed at a central location on the back of the shell. Preference is given to placing the belt loop relatively high on the back of the head. The strap additionally can have a handle feature at or near each end 11a, 11f. A loop handle 15 is illustrated for example. Thus to facilitate manipulation of the strap in an emergency situation, a finger can be inserted into the loop handle to conveniently grasp the strap and apply tension as will be explained, below. Other representative examples of other suitable handle features include a ball, a rod affixed by its mid-point to the strap end, a button and the like.

The rings 12a and 12b are turning guides for the strap. Known escape hoods that fit the hood in proper orientation to the users head with straps are different. In those conventional hoods, after adjusting the tension on the strap, the strap is clamped to this forward location on the shell to maintain the tension and position of the mask. Typically a jamming type clamp is used. For example the clamp is generally with a movable bar that can slide in the longitudinal direction of the strap as guided by side members of the rectangular clamp. To tension that type of strap, the strap is woven through the rectangular clamp structure and passed between an end of the ring and the bar. Then the bar is moved against the end of the clamp to jam the strap. The bar is maintained biased against the end by strap tension. The disadvantages of such a system are that it requires two hands to set each side of the hood, it is a relatively complicated maneuver to undertake, especially in an emergency escape situation, it calls for the tension on the strap to keep the strap locked in position, and each side must be adjusted separately so it may take several attempts to end up with the sight shield and cartridge centrally positioned on the users face.

In contrast, the novel hood straps merely pass through the rings 12a and 12b without hooking or catching or being tied down to the rings in any way. This hood uses hook-and-loop style fasteners to lock the strap in its desired position. According to this invention, an area of the shell proximate to each of the user's ears includes a first part of a hook-and-loop style fastener. The left side area 16a that has, for example, loops, (schematically represented by elements 17) is shown in FIG. 2. Additionally, the outwardly facing side of strap 11 includes a section of the second part of the hook-and-loop style fastener complementary to the first part. FIG. 2 illustrates section 18a on the left side of the hood. This section contains hooks (schematically represented by element 19 which are adapted to mate with loop elements 17. The hooks and loops are interchangeable such that elements 17 could be hooks and element 19 could be loops.

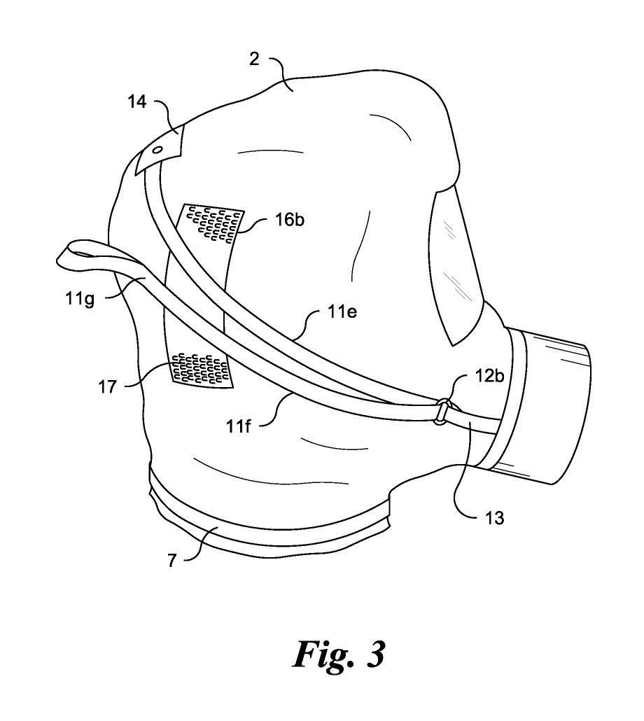

The same fastening system is used on the other side of the hood. This can be seen in FIG. 3 which illustrates a view of the right side of hood 10 in which right length 11f of the strap is secured to the hood in accordance with the method of this invention for donning the escape hood. An area 16b of the first hook-and-loop fastener part is located on the shell proximate to the right ear of the user. Right side strap length 11f has been pulled laterally outward, i.e., to the right, from the head and then rearward. Right end 11g has been brought close to the back of the head such that the second hook-and-loop fastener part (not shown) on the former outward facing side of strap length 11f, faces and contacts first hook-and-loop fastener part 17 in area 16b. FIG. 3 further illustrates that strap 11 simply passes through and is turned on right ring 12b. The ring is seen to be pivotally affixed to the front of the hood by tab 13. The tab can be bound to the hood by conventional means such as with threads or adhesive, for example. The ring is held such that it can pivot forward or rearward about the rear edge of tab 13.

The significant advantages of the novel hood and securing system begin with the fact that only one hand is needed to secure each side of the strap to the shell. In practice, the user places the hood over the head and loosely aligns the sight shield and cartridge to cover the face in a comfortable orientation for viewing and breathing. Then, letting the hood sit still on the head, the user grasps the left end 11a of the strap with the left and the right end 11g of the strap with the right hand. Conveniently and beneficially these forward extending strap ends are in view and easily accessible to the user. The user might grasp both ends at the same time, however, the user can reach for and take hold of the ends in two steps. Next, while holding both ends in respective hands, the user simultaneously draws both ends outwardly and rearwardly to exert even tension on both strap sides. The tension pushes the rear of the hood against the back of the user's head due to the run of strap between the two rings being pulled forward. Also the rings are pivoted rearwardly along with the direction of the end portions of the straps. With comfortable tension on both straps, they are simultaneously contacted with the areas of the first hook-and-loop fastener part on respective sides. The hook-and-loop fasteners engage and thus hold tension on the straps as seen in FIG. 3. The elastic neck strap automatically seals the hood at the collar. If necessary, the user can make follow-up adjustment at this time.

Evident from the previous description, the strap tension is adjusted for comfort of the user in a single step. Because both sides are clamped simultaneously, orientation of the hood on the head is maintained for a good fit. It is also done quickly without having to manipulate a clamp or tie the strap.

Another important feature of this escape hood is that the rings 12a and 12b are preferably in the shape of complete circles. Unlike other shapes, such as “D” rings, rectangular rings or other shapes that can bind the strap or have to be repositioned prior to tensioning, these rings always present a smooth bearing surface in contact with the strap 11. Thus the rings are constantly ready for hood deployment without further adjustment.

It is a concern with conventional securing systems in which the strap can be a loose strip not attached to the shell until tensioned, that the strap can become separated from the shell. For example, the strap end can retract rearwardly through the forward clamp mechanisms during the rush to unpack and don the hood in an emergency. Another mistake might be to pull the conventional strap too hard from one side causing the opposite strap end to pull completely out of one or both clamp mechanisms. In addition to the difficulty of re-threading such a strap in a panic situation, the strap might become lost altogether.

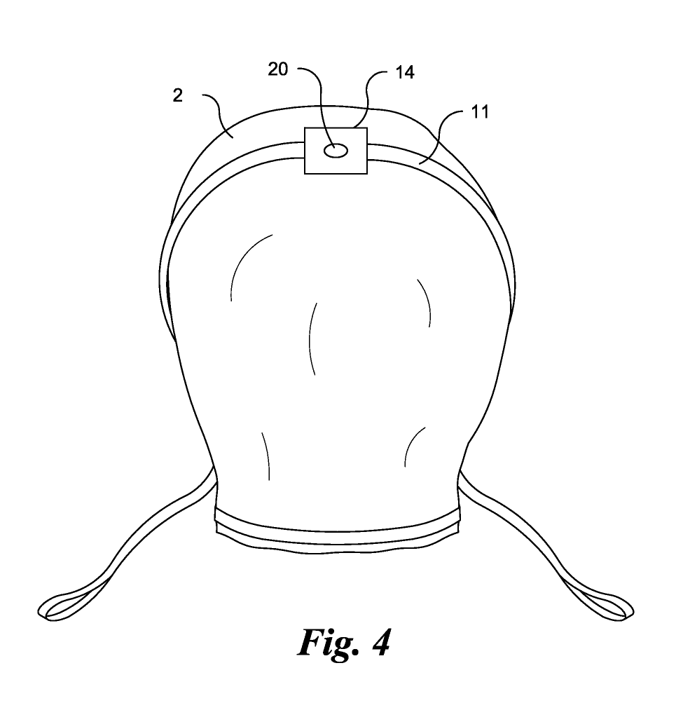

The novel hood provides solutions for such problems. Firstly, the hood can include a belt loop 14 positioned centrally, and preferably high on the rear (FIG. 4.) To affix the strap so that it cannot be separated from the hood by excessive pulling, there is provided an attachment means 20 that joins the strip 11 where it passes through the belt loop 14. The attachment means can be any conventional permanent fastener type. Representative examples include adhesive, stitches of thread, thermal welding, rivet and the like. FIG. 4 illustrates a rivet. The rivet or other attachment means preferably should connect the strap with the outer side of the belt loop and not pierce the shell of the hood which would weaken if not compromise the vapor- and liquid-tight integrity of the shell.

Although specific forms of the invention have been selected in the preceding disclosure for illustration in specific terms for the purpose of describing these forms of the invention fully and amply for one of average skill in the pertinent art, it should be understood that various substitutions and modifications which bring about substantially equivalent or superior results and/or performance are deemed to be within the scope and spirit of the following claims. The entire disclosures of U.S. patents and applications identified in this disclosure are hereby incorporated by reference herein.

What is claimed is:

1. A protective hood for a user to wear in emergency escape from a life-threatening hazard comprising, (a) a collapsible shell of vapor barrier material, (b) integrated into the shell, a forward-facing, broad, transparent sight shield, (c) a cartridge adapter for an air-purifying filter cartridge, the adapter disposed on the shell forward and below the sight shield, (d) an air-purifying filter cartridge attached to the cartridge adapter, (e) a left side ring pivotally affixed to a left side of the hood forward on the shell proximate to the adapter, (f) a right side ring pivotally affixed to a right side of the hood forward on the shell proximate to the adapter, (g) strap means of elongated fabric extending through the left side ring and the right side ring for securing the hood in fixed position on a head of the user.

2. The protective hood of claim 1 in which the right side ring and the left side ring are free of means for clamping the strap means of elongated fabric.

3. The protective hood of claim 1 in which the strap means comprises a left side elongated strap extending from a free left end rearward through the left side ring to a fixed left end affixed to the left side of the hood, and, a right side elongated strap extending from a free right end rearward through the right side ring to a fixed left end affixed to the right side of the shell

4. The protective hood of claim 1 in which the strap means comprises a single continuous elongated strap having a left end at one extreme free of the hood and a right end at the opposite extreme free of the hood, the strap extending from the left end rearward through the left side ring, rearward along the left side of the hood around a back of the hood, forward along the right side of the hood, forward through the right side ring to the right end.

5. The protective hood of claim 4 in which the right end and left end each comprises handle means for manually grasping the right end and the end, respectively.

6. The protective hood of claim 4 in which each ring has circular shape.

7. The protective hood of claim 4 which further comprises an area proximate to a left ear of the user outside the shell comprising a first part of a hook-and-loop style fastener and an area proximate to a right ear of the user outside the shell comprising a first part of a hook-and-loop style fastener, and in which a section of the strap intermediate the left side ring and the left end comprises a second part of a hook-and-loop style fastener and a section of the strap intermediate the right side ring and the right end comprises a second part of a hook-and-loop style fastener.

8. The protective hood of claim 7 in which the first part of the hook-and-loop style fastener of the area proximate to the left ear is operable to engage the second part of the hook-and-loop style fastener on the strap intermediate the left side ring and the left end and the first part of the hook-and-loop style fastener of the area proximate to the right ear is operable to engage the second part of the hook-and-loop style fastener on the strap intermediate the right side ring and the left end when the right end and the left end are positioned rearwardly relative to the hood.

9. The protective hood of claim 4 which further comprises a belt loop on shell at the back, and in which a mid-region of the strap approximately equidistant from the left end and the right end passes through the belt loop.

10. The protective hood of claim 9 further comprising anchoring means for affixing the mid-region of the strap to the belt loop.

11. The protective hood of claim 5 in which the handle means comprises a loop of a size effective to enable the user to grasp each end by inserting a finger in the loop.

12. The protective hood of claim 4 in which each of the right end and the left end comprises a blocking member of a size effective to prevent rearward passage of the left end and the right end through the left side ring and the right side ring, respectively.

13. The protective hood of claim 1 in which the air-purifying cartridge is removably attached to the hood by the cartridge adapter, and further comprising a spare air-purifying cartridge not installed on the hood that is suitable for replacing the air-purifying cartridge removably attached to the adapter.

14. A method of donning a protective hood on a head of a user in emergency escape from a life-threatening hazard comprising the steps of
(A) providing a protective hood comprising
(1) a collapsible shell of vapor barrier material,
(2) integrated into the shell, a forward-facing broad, transparent sight shield,
(3) a cartridge adapter for an air-purifying filter cartridge disposed on the shell forward and below the sight shield,
(4) an air-purifying filter cartridge attached to the cartridge adapter,
(5) a left side ring pivotally affixed to a left side of the hood forward on the shell proximate to the cartridge adapter,
(6) a right side ring pivotally affixed to a right side of the hood forward on the shell proximate to the cartridge adapter,
(7) a single continuous elongated strap having a left end at one extreme free of the hood and a right end at the opposite extreme free of the hood, the strap extending from the left end rearward through the left side ring, rearward along the left side of the hood around a back of the hood, forward along the right side of the hood, forward through the right side ring to the right end,
(8) a left area proximate to a left ear of the user outside the shell comprising a first part of a hook-and-loop style fastener and a right area proximate to a right ear of the user outside the shell comprising a first part of a hook-and-loop style fastener, and
(9) a left section of the strap intermediate the left side ring and the left end comprising a second part of a hook-and-loop style fastener and a right section of the strap intermediate the right side ring and the right end comprising a second part of a hook-and-loop style fastener,
(B) placing the protective hood over the head such that the sight shield, cartridge adapter and cartridge are covering the face of the user,
(C) grasping the left end of the strap by the user's left hand, and grasping the right end of the strap by the user's right hand,
(D) simultaneously drawing the right end and left end rearwardly along respective sides of the hood with tension effective to pull the left side ring and the right side ring in cooperation with the strap extending between the left ring and the right ring, and
(E) contacting the second part of the hook-and-loop style fastener of the left section of the strap with the first part of the hook-and-loop style fastener part of the left area on the shell and contacting the second part of the hook-and-loop fastener of the right section of the strap with the first part of the hook-and-loop fastener of the right area on the shell, thereby attaching the strap to the hood such that the hood is properly secured in place on the head.
